(19) United States
(12) Patent Application Publication
(10) Pub. No.: US 2002/0156649 A1
(43) Pub. Date: Oct. 24, 2002

(54) Method and system for organizing a golf tournament

(76) Inventor: James Edward Edgar, (US)

Correspondence Address: Wilson Clark, Suite 800, 885 West Georgia Street, Vancouver, British Columbia, V6C 3H1, CA

(21) Appl. No.: 10/125,380

(22) Filed: Apr. 19, 2002

Related U.S. Application Data
(60) Provisional application No. 60/285,099, filed on Apr. 19, 2001.

(51) Int. Cl. G06F 17/60

(52) U.S. Cl. 705/1

(57) ABSTRACT

A method and system for organizing a golf tournament is provided, wherein players may be selected from a large geographical area. The players are divided into groups based on skill levels and geographical location into groups of three, who play at least a round of golf together with a representative. The representative serves as the referee for the group, and the winner of each group moves on to the next round. Once the number of winners has been reduced below a specified number, a tournament is held, and the winners of the tournament are awarded prizes.

### NOTICE REGARDING COPYRIGHTED MATERIAL

A portion of the disclosure of this patent document contains material which is subject to copyright protection. The copyright owner has no objection to the facsimile reproduction by anyone of the patent document or the patent disclosure as it appears in the public Patent Office file or records but otherwise reserves all copyright rights whatsoever.

### TECHNICAL FIELD

This invention relates to systems for organizing tournaments, and particuarly golf tournaments with entrants from a large geographical area.

### BACKGROUND

A professional golf tournament is a contest to determine the best golfer in the field. To enter an officially sanctioned tournament involving a purse or cash prize, the player must be qualified and will usually carry a tour card indicating membership. Organizations that put on professional tournaments such as the CPGA and PGA keep player and event statistics and are responsible for implementing and enforcing the official rules of golf. The best golfer or winner of the tournament is the golfer with the low score after 4 rounds of golf. The first two rounds of a professional tournament typically narrow the field by approximately 50% (usually about the best 70 players compete in the final two rounds). These tournaments will often take place with a ‘gallery’, i.e. members of the public in attendance, the public is not otherwise involved except as observers. Larger and more lucrative tournaments are often presented on television as entertainment. Course Marshals are present throughout the tournament to make rulings and ensure that all players abide by the rules of golf as defined by the country in which the event is being played and by the organization putting on the tournament. The Course Marshals or officials do not participate in the tournament except to observe play and make rulings on enforcement and implementation of the rules of golf. In this style of tournament, all the participants play at the same golf course and usually at or around the same time.

One company operating in the U.S. offers a national tournament for all skill levels using a handicap system. The company recognizes officially sanctioned handicaps but adjusts them to its own system. Participants in the tournament receive a handicap from the company and compete, either in “leagues” of four players or in one-day qualifying events. Groups of four can enter as a league and after the first stage one of the four players will advance to the next stage of the tournament (the regional final). In the league scenario the league decides if the winner will be determined by from one to four 18-hole rounds but the first stage must be completed by a predetermined date. The winner is the player with the lowest net score and advances to the regional final. In the case of the one-day qualifying tournament, all players play the same course on the same day. Those players with a low-net score in the top 25% (plus ties) advance to the regional final. The handicapping system is used in an attempt to eliminate ‘sandbagging’ or cheating. Players' handicaps may be adjusted after each 18-hole score is entered so that no player will be far below his or her handicap for consecutive rounds. USGA rule 10.3 defining statistical adjustments, is brought to bear any time a player enters two scores 3 strokes below his or her handicap in a tournament situations within a one year period. Local winners advance to the regional finals. Fifty players in each of eight categories advance from the regional finals to the national championship or final tournament where they will play for a cash purse. For the national championship the field is divided into eight divisions, based on handicap, with a winner in each division. The winner of each division wins the same amount of money.

In this tournament system the play in the local event leading to the regional final, is monitored by the players themselves. Players entering as a league in the local event could be in a different ‘flights’ or divisions and three of the four players are eliminated in the first stage (using the handicap system). Only the players advancing to the regional finals will be divided into four divisions based on handicap where players will compete with others within their own division. The winners in each division are established by the low net score, using the handicap system and will be eligible for the national final. In the regional event players once again monitor their own play.

An annual tournament leaves the golfers eliminated in the first round without the opportunity to compete for money in an organized event for the rest of the year. One such tournament is organized to take place over a nine-month period. In many areas of the world the golf season doesn't last nine months making that model impractical. Requiring golfers to enforce the rules on golf on themselves can lead to cheating and/or arguments. Furthermore, golfers do not compete with others at their skill level until the national final is reached. The possibility of providing golfers at all skill levels an opportunity to engage in fair competition for cash prizes, can be more fully addressed by practicing the system and method according to the invention.

### SUMMARY OF THE INVENTION

A method and system for organizing a golf tournament is provided, wherein players may be selected from a large geographical area. The players are divided into groups based on skill levels and geographical location into groups of three, who play at least a round of golf together with a representative. The representative serves as the referee for the group, and the winner of each group moves on to the next round. Once the number of winners has been reduced below a specified number, a tournament is held, and the winners of the tournament are awarded prizes.

### DETAILED DESCRIPTION OF PREFERRED EMBODIMENTS

The goal of a tournament according to the invention is to provide annual local, regional and national events. These events will provide golfers anywhere in a large geographic region, such as a country, to compete with other golfers at the same skill level for cash purses comparable to those played for by professionals. Because large sums of money may be awarded to the winners, play must be monitored to insure that the rules of golf are being followed and that the winner is determined fairly. One method that the organizer may utilize to achieve this end is to provide representatives that play with entrants.

The organizer sponsors different levels of tournament called, for the purposes of this application, standard and premium events. The representative may play in any one or any number of stages of the tournament as determined by the organizer. The organizer may sponsor a variety of events not covered in this document however, in all formats fair play should be assured for all entrants and the spirit of the rules of golf should be enforced. The organizer may determine which golf course and at which time, one or all rounds of an event take place. Other tournament examples may include 9-hole events, one-day events held on executive length facilities, weekend events or a myriad of other possibilities. All such tournaments should employ representatives to govern play, such as making rulings on the applicable rules of golf, insisting on a reasonable pace of play and assisting in the organization of events. Preferably two types of representatives will be employed, local and regional. Local representatives preferably, have their green fees paid for and receive a small payment when playing as representatives in the organizer's events.

Regional representatives will play a much larger roll in the organization of events. The regional representative may receive a percentage of the gross revenues collected by the organizer from the events they help organize. All regional tournaments may determine a winner after two stages. A stage is a portion of the event in which players are eliminated from contention and may consist of one or more rounds of golf. The standard regional tournament may allow participants in the tournament to monitor their own play for the first stage of the event. The first stage preferably consists of two rounds of golf. The tournament should then employ representatives for the remaining stage, which may also consist of two 18-hole rounds of golf. The premium regional tournament may employ representatives in all stages of the event, each stage consisting of one or two 18-hole rounds of golf (but could be nine-hole rounds).

The players must register for the tournaments, preferably by using the organizer's website, and provide contact information. They should also provide all handicap information, their address, phone number, the geographic zone in which they wish to compete, and hopefully an email address. Handicap information will be verified when possible and in the case of event winners the organizer may require a period of time to confirm that no misrepresentation of the players handicap has taken place, whether intentional or otherwise, before providing the prize money. Representatives may contact the players that register as individuals and organize foursomes of the same skill level to enter the first stage which preferably consists of two rounds of golf. It is also possible for groups to register as foursomes for the first stage of the event. In either case, all players should enter their own score and the scores of the other players in their group, by phone fax or email so it can be entered into a tournament tracking system, which may be available at the organizer's website. To discourage cheating, any discrepancies within a group's scorekeeping may potentially result in the disqualification of the entire group. All players' may also be required to provide their score for handicap determination, for example by entering their score in the handicap tracking software available on the organizer's website. Winners will then be entered into a new group for the next stage of the tournament.

The Representative

In this method and system of the invention the representatives of the organizer play along side the competitors but do not compete. This is an original concept in tournament play. No other golf event in the world involves its employees in the same way. Representatives should exhibit a comprehensive understanding of the rules of golf. The representatives will facilitate the completion of events and ensure fair play. The representative may keep the scores of all players in the group, should make all rulings on the applicable rules of golf and should demand a reasonable pace of play. The representative may observe the skill level of the players and report an opinion as to the accuracy of the players' handicap information. The representative may observe play and insure that all players understand and observe all applicable rules and may have the authority to disqualify players. Regional representatives may be encouraged to organize local events using the organizers' resources and thereby earn a percentage of the registration fees. For example, if a representative organizes a tournament in his or her area and 1000 golfers pay a registration fee $49.00, that representative may receive 6% of the monies collected or $2940.00. Representatives will not be eligible to win events or share in the purse of tournaments in which they function as representatives.

Divisions

The organizer may split the field into eight divisions determined by handicap allowing golfers of all skill levels to compete fairly. Examples of potential divisions are for players with handicaps of 0-4, 5-8, 9-12, 13-16, 17-20, 21-24, 25-28, 29+. More or less divisions are possible. Handicap rules allow for handicaps from 0 to 46. Some premium events may not acknowledge handicaps over 16; players with higher handicaps may enter but have to play to a 16 handicap. Tournaments could take place in which the divisions consist of players with the same handicap, or where the divisions include players with handicaps 0-9, 10-20, 21-30, and 31-40. The purpose of the divisions is to create a fair and equal opportunity to win for all entrants at their own skill level. However, once the divisions are determined for a tournament those divisions should remain consistent throughout, and players preferably will play within their own division throughout the tournament.

Golfers without registered handicaps, or with handicaps provided by organizer accepted handicap tracking systems, should be able to enter their last five scores into the system maintained by the organizer in order to receive an updated handicap. The handicapping system is preferably available at the organizers' website. Those players with an accepted handicap are preferably still required to enter their handicap into the organizers' system. Each player should enter into the organizers handicapping system their score from each round played in an organizer event. Therefore, as scores are entered from rounds played in organizer events, the player's handicap may be adjusted to insure continued fair and equitable tournament conditions.

The Standard Event

The standard tournament preferably consists of two stages, each stage preferably being two 18-hole rounds of golf. The winners are determined by the low net scores of the final stage. Cash prizes may be awarded to first, second, third, fourth and fifth place in each division. Usually first place should receive the largest prize, or sum of money, however, a prize may be awarded to only first place or the entire field may receive the same level of prize. The first two rounds, or first stage, may take place at any course with or without a slope rating. The organizer may specify courses and times for the final two rounds, or second stage. The following model illustrates how the standard event may function:

1. 1000 players pay an entrance fee of $49 creating $49,000 in revenue.

2. Foursomes are then organized for each division, either by groups of four players in the same division registering as a group, or by the organizer selecting groups of four players in the same division and in the same geographical region.

3. The groups of four play two 18-hole rounds of golf to determine a winner. The winners advance to the second stage.

4. The third round of the event is played with representatives playing in each foursome at a cost to the organizer of approximately $8300.00.

5. The final round may consist of the same field (32 players in each division) again playing with organizer representatives, at a cost to the organizer of approximately $8300.00. The low net score of the final two rounds (the second stage), will decide the winner in each division.

6. The top five players in each division will receive cash prizes from the total purse of $24,500.00. First place in each division will win $2,000.00, second $500.00, third $300.00, fourth $200.00 and fifth place will win $100.00.

7. This will produce a profit of approximately $8,834.00.

Tournament entrants may play in a group of four and three of each four players will be eliminated after the first stage. Players may be able to enter as foursomes or as individuals who will then be put in foursomes by the regional representative. The player with the low net score of each group of four advances to the second stage. In the second stage each group should play with one organizer representative and all players should play the same golf course or the same two courses. The low net score of the final two rounds determines the winner. The organizer representative with each group will make all rulings related to the applicable rules of golf and insure fair play.

The Premium Event

The premium event could follow the same format as the standard event except that the organizer representative may play as a part of the foursomes during all stages. In this format only 66% of the field would be eliminated after the first stage. This raises the cost of the event and therefore, requires a higher entry fee. The cash prize should also be greater.

The Championship Event

The championship event will preferably consist of four stages. In the first stage, the foursomes may decide how many rounds they wish to play to determine a winner. One player from each foursome should advance to the second stage. The second stage may require representatives to fill out foursomes in some less populated regions. Preferably, the low 25% in each division advance to the third stage. In the third stage, representatives should play with each foursome to govern fair play and the observance of the applicable rules. The participants should provide their own transportation to attend a one-day event, with all contestants, on the same course to determine who qualifies for the final stage of the event. Once again, the low 25% should advance. The final stage to decide the champion may be a two or three day event, where a fee may be paid to the hosting facility to provide a full turnkey tournament.

While the principles of the invention have now been made clear in the illustrated embodiments, it will be immediately obvious to those skilled in the art that many modifications may be made of structure, arrangements, and algorithms used in the practice of the invention, and otherwise, which are particularly adapted for specific environments and operational requirements, without departing from those principles. The claims are therefore intended to cover and embrace such modifications within the limits only of the true spirit and scope of the invention.

What is claimed is:

1. A method of organizing a golf tournament comprising the steps:
(a) providing a plurality of players;
(b) dividing said players into groups;
(c) providing a representative for each group of players;
(d) selecting a first winner from each group of players;
(e) providing a championship tournament for said first winners;
(f) selecting a plurality of second winners of said championship tournament;
(g) providing prizes to said second winners.
